(19) United States
(12) Patent Application Publication
(10) Pub. No.: US 2024/0382053 A1
(43) Pub. Date: Nov. 21, 2024

(54) NOISE REDUCTION DEVICE FOR CLEANERS

(71) Applicant: LG ELECTRONICS INC., Seoul (KR)

(72) Inventors: Dongrak CHOI, Seoul (KR); Geunbae HWANG, Seoul (KR); Sunghyun KI, Seoul (KR)

(21) Appl. No.: 18/667,140

(22) Filed: May 17, 2024

(30) Foreign Application Priority Data
May 18, 2023 (KR) 10-2023-0064351
Nov. 29, 2023 (WO) PCT/KR2023/019399

(51) Int. Cl. A47L 9/00

(52) U.S. Cl. CPC A47L 9/0081

(57) ABSTRACT

A noise reduction device for cleaners includes: a first flow path having a first end communicating with an air outlet and a second end that is open, the first flow path extending in a first direction; and a second flow path having a first end connected between the first end and the second end of the first flow path and a second end that is closed, the second flow path extending in a second direction intersecting the first direction, wherein the first flow path is disposed to surround the second flow path.

### CROSS-REFERENCE TO RELATED APPLICATION(S)

This application claims priority under 35 U.S.C. § 119 to Korean Application No. 10-2023-0064351 filed in Korea on May 18, 2023 and PCT/KR2023/019399 filed Nov. 29, 2023, whose entire disclosures are hereby incorporated by reference.

### BACKGROUND

### 1. Field

The following disclosure relates to a noise reduction device for cleaners.

### 2. Background

Cleaners may be classified into a manual cleaner for cleaning while a user directly moves the cleaner, and a robot cleaner for cleaning while traveling by itself. In addition, the manual cleaner may be classified into a canister-type cleaner, an upright-type cleaner, a handy-type cleaner, a stick-type cleaner, or the like, depending on the shape of the cleaner.

The cleaner includes an impeller providing a driving force for sucking dust and a suction motor rotating the impeller. Noise of the cleaner is generated due to the rotation of the impeller in the cleaner. The noise of the cleaner includes noise having a uniform frequency depending on a rotation period of the impeller.

The noise of the cleaner mainly includes noise caused by the operation of a motor, and flow noise caused when air (flow) passes through an air inlet and is discharged through an air outlet. Most of the noise from the motor appears as a peak component, and the noise from the air flow appears as base noise.

The noise of the cleaner is generated at the air outlet, but the air outlet is a hole for discharging air, such that it is difficult to provide a sound insulation structure for the air outlet. Further, if the air outlet is blocked to reduce noise, a suction performance of the cleaner is reduced.

Korean Laid-Open Patent Publication No. 2010-0109775 (hereinafter referred to as related art 1) discloses a noise reduction device for a vacuum cleaner including a vibration isolation cover for absorbing vibration from a fan motor of the vacuum cleaner, a soundproof pad for blocking noise generated by vibration of the fan motor, and a grill for guiding air to be discharged in a direction inclined at a predetermined angle. By using this structure, related art 1 reduces the noise generated during operation of the vacuum cleaner as much as possible. However, related art 1 has a problem in that by merely providing the inclined grill through which air is discharged, noise is not reduced effectively, and flow noise (base noise) cannot be improved.

Korean Laid-Open Patent Publication No. 2006-0062145 (hereinafter referred to as related art 2) discloses a noise reduction device for fan motor of a vacuum cleaner for reducing noise generated by the fan motor. The noise reducing device disclosed in related art 2 includes a fan motor for generating an air flow, a front support member disposed at the front of the fan motor so that the fan motor is supported by the front support member, an internal noise absorption member disposed outside the fan motor so as to absorb noise generated by the fan motor, and an external noise absorption member disposed outside the internal noise absorption member so as to absorb noise generated by the fan motor. Further, a plurality of air vent holes, through which air passes, are formed in an outer circumferential surface of a noise reduction member. However, related art 2 has a problem in that production cost increases due to the use of the internal/external noise absorption members, and effects vary depending on materials, and when applied to cleaners, it is difficult to achieve standardization and common use, thereby leading to an increase in production cost.

Korean Patent No. 10-1309678 (hereinafter referred to as related art 3) discloses a device for reducing noise and vibration of an impeller in a vacuum cleaner, in which as for the air drawn in through an air inlet of the impeller, noise is canceled out by generating mutual resonance between a noise waveform of air introduced into a cylindrical support stand and a noise waveform of air passing through an air hole of the support stand and temporarily staying in a cylindrical intermediate pipe installed at a longitudinal center of the support stand through the impeller to flow downward, thereby significantly reducing severe noise and vibration generated due to the air rapidly drawn into the impeller, preventing noise pollution of the surroundings due to severe noise from the impeller of a vacuum cleaner, and changing air cavities between blades due to an increase in air drawn into the impeller of a vacuum cleaner, so as to reduce the noise from an impeller drive motor, as well as to extend lifetime of the vacuum cleaner and the impeller. However, related art 3 has a problem in that the device is limited to the noise of the impeller in the cleaner, such that flow noise (base noise) cannot be reduced, and the device may be used at limited positions, thereby making it difficult to achieve common use for various types of cleaners.

The above references are incorporated by reference herein where appropriate for appropriate teachings of additional or alternative details, features and/or technical background.

### BRIEF DESCRIPTION OF THE DRAWINGS

The embodiments will be described in detail with reference to the following drawings in which like reference numerals refer to like elements wherein:

FIG. 1 is a side elevation view illustrating a state of use of a cleaner 1 according to an embodiment of the present disclosure;

FIG. 2 is a perspective view of the cleaner 1 of FIG. 1, from which a nozzle module 70 is removed;

FIG. 3 is a side elevation view of the cleaner 1 of FIG. 2;

FIG. 4A is a top elevation view of the cleaner 1 of FIG. 2;

FIG. 4B is a top elevation view of a cleaner 1 according to another embodiment of the present disclosure;

FIG. 5 is a cross-sectional view of the cleaner 1 of FIG. 3, taken horizontally along line S1-S1′;

FIG. 6 is a cross-sectional view of the cleaner 1 of FIG. 4A, taken vertically along line S2-S2′;

FIG. 7 is a perspective view of a noise reduction device according to an embodiment of the present disclosure, which is coupled to the cleaner 1 illustrated in FIG. 2;

FIG. 8 is a diagram illustrating only an upper portion of a main body of the cleaner and the noise reduction device of FIG. 7 according to an embodiment of the present disclosure;

FIG. 9 is an exploded view of the cleaner and the noise reduction device illustrated in FIG. 8;

FIG. 10 is a longitudinal sectional view of the cleaner and the noise reduction device illustrated in FIG. 8;

FIG. 11 is a longitudinal sectional view of a noise reduction device according to an embodiment of the present disclosure;

FIG. 12 is a cross-sectional perspective view of the noise reduction device illustrated in FIG. 11;

FIG. 13 is an exploded perspective view of a noise reduction device according to another embodiment of the present disclosure;

FIG. 14 is a longitudinal sectional view of a noise reduction device according to yet another embodiment of the present disclosure;

FIG. 15 is a cross-sectional perspective view of the noise reduction device illustrated in FIG. 14;

FIG. 16 is a view of a portion of a lower member of FIG. 15 when viewed from a central axis; and

FIG. 17 is a diagram illustrating levels of noise with respect to frequency in a comparative example and an example.

### DETAILED DESCRIPTION

In order to describe the present disclosure, the following description will be given with reference to a space orthogonal coordinate system of X, Y, and Z axes orthogonal to each other. Each axis direction (X axis direction, Y axis direction, Z axis direction) means both directions in which each axis extends. The plus sign in front of each axis (+X axis direction, +Y axis direction, +Z axis direction) means a positive direction, which is one of both directions in which each axis extends. The negative sign in front of each axis (−X axis direction, −Y axis direction, −Z axis direction) means a negative direction, which is one of both directions in which each axis extends.

The expression referring to the directions such as “before (+Y)/after (−Y)/left (+X)/right (−X)/upper (+Z)/lower (−Z)” which will be described below is defined with reference to XYZ coordinate axes. However, it should be understood that these expressions are used for clearly understanding, and that each direction can be defined differently as well depending on where the reference is placed.

The use of terminologies such as “first, second, third, etc.” in front of elements described below is intended only to avoid confusion of elements, it is irrelevant to the order, importance, or master relationship between the elements. For example, some embodiments may include only a second element without a first element. As used herein, the singular forms “a”, “an” and “the” include plural forms as well unless the context clearly dictates otherwise.

Cleaners according to the present disclosure include a manual cleaner or a robot cleaner. Hereinafter, a cleaner 1 according to an embodiment of the present disclosure will be described using a handy-type manual cleaner as an example, but the cleaner according to the present disclosure is not limited thereto.

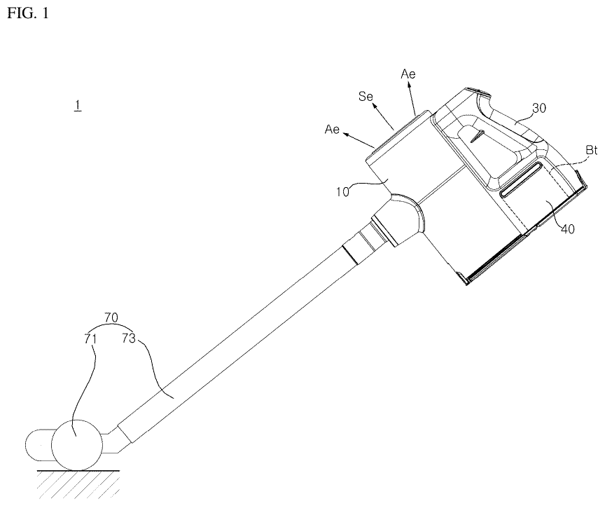

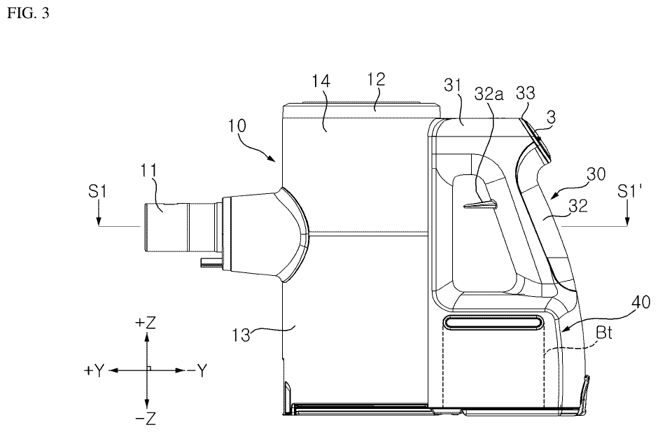

Referring to FIGS. 1 to 6, the cleaner 1 according to an embodiment includes a main body 10 having a flow path P for guiding sucked air to the outside. The cleaner 1 includes a dust separator 20 disposed in the flow path P and configured to separate dust in the air. The cleaner 1 includes a handle 30 mounted to a rear side of the main body 10. The cleaner 1 includes a battery Bt supplying power and a battery housing 40 in which the battery Bt is accommodated. The cleaner 1 includes fan modules 50, 50′ disposed in the flow path P and configured to move the air in the flow path. The cleaner 1 includes filters 61 and 62 disposed in the flow path P and configured to separate dust in the air, in addition to the dust separator. The cleaner 1 includes a nozzle module 70 detachably connected to a suction part 11 of the main body 10. The cleaner 1 includes an input unit 3 for selecting on or off or a suction mode of the cleaner 1, and an output unit 4 for displaying various states of the cleaner 1.

The cleaner 1 includes one or more noise control modules 80, 80′, 180, 280, 380, and 980 configured to perform at least one of i) a first function of reducing a level of the noise of a relatively low frequency of the audible frequency and ii) a second function of increasing a level of the noise of a relatively high frequency of the audible frequency. The noise control modules include speakers 89 and 989 for outputting sound. In some embodiments, the cleaner 1 may further include a sound conveying conduit 90 for conveying the sound of the speakers 89 and 989 to sound outlets 10b and 10b′.

Referring to FIG. 1, the nozzle module 70 includes a nozzle part 71 provided to suck in outside air and an extension pipe 73 elongated from the nozzle part 71. The extension pipe 73 connects the nozzle part 71 and the suction part 11. The extension pipe 73 guides the air sucked from the nozzle part 71 to be introduced into a suction flow path P1. One end of the extension pipe 73 may be detachably coupled to the suction part 11. A user may perform cleaning by moving the nozzle part 71, placed on the floor, while holding the handle 30.

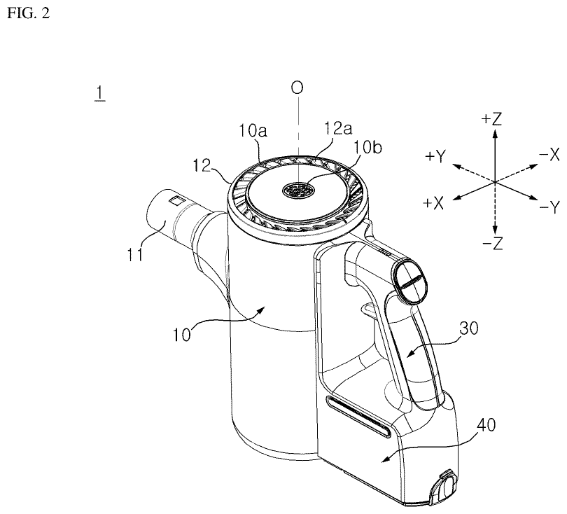

Referring to FIGS. 2 to 6, the main body 10 forms the exterior of the cleaner 1. The main body 10 may have a vertically long cylindrical shape as a whole. The dust separator 20 is accommodated in the main body 10. The fan modules 50 and 50′ are accommodated inside the main body 10. The handle 30 is coupled to the rear of the main body 10. The battery housing 40 is coupled to the rear of the main body 10.

The main body 10 includes the suction part 11 for guiding air into the main body 10. The suction part 11 has the suction flow path P1. The suction part 11 may protrude forward of the main body 10.

The main body 10 includes discharge covers 12 and 12′ having air inlets 10a and 10a′. The discharge covers 12 and 12′ may further include the sound outlet 10b and 10b′. The discharge covers 12 and 12′ may form an upper surface of the main body 10. The discharge covers 12 and 12′ cover an upper portion of a fan module housing 14.

The main body 10 includes a dust collector 14 for storing dust separated by the dust separator 20. At least a portion of the dust separator 20 may be disposed in the dust collector 13. An inner surface of an upper portion of the dust collector 13 may perform the function of a first cyclone portion 21 which will be described later (in this case, the upper portion of the dust collector 13 may be referred to as the first cyclone portion 21). A second cyclone portion 22 and a dust flow guide 24 are disposed in the dust collector 13.

The dust collector 13 may have a cylindrical shape. The dust collector 13 may be disposed under the fan module housing 14. Dust storage spaces S1 and S2 are formed in the dust collector 13. A first storage space S1 is formed between the dust collector 13 and the dust flow guide 24. A second storage space S2 is formed in the dust flow guide 24.

The main body 10 includes the fan module housing 14 formed therein to accommodate the fan modules 50 and 50′. The fan module housing 14 may extend upward from the dust collector 13. The fan module housing 14 has a cylindrical shape. An extension portion 31 of the handle 30 is disposed at the rear side of the fan module housing 14.

The main body 10 includes a dust cover 15 for opening and closing the dust collector 13. The dust cover 15 may be rotatably coupled to a lower side of the dust collector 13. The dust cover 15 may rotate to open and close the lower side of the dust collector 13. The dust cover 15 may include a hinge (not shown) for rotation. The hinge may be coupled to the dust collector 13. The dust cover 15 may open and close both the first storage space S1 and the second storage space S2 together.

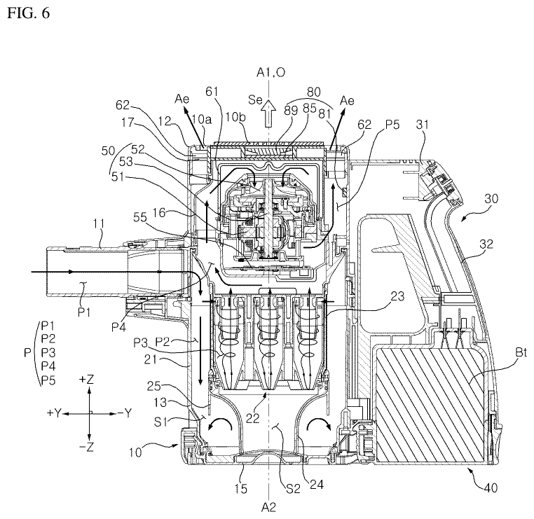

The main body 10 may include an air guide 16 for guiding air discharged from the dust separator 20. The air guide 16 forms fan module flow paths P4 and P4′ for guiding the air from the dust separator 20 to impellers 51 and 51′. The air guide 16 includes exhaust flow paths P5 and P5′ for guiding air, having passed through the impellers 51 and 51′, to the air outlets 10a and 10a′. The air guide 16 may be disposed in the fan module housing 14. For example, referring to FIG. 6, the air guide 16 may form the flow paths P4 and P5 so that air having passed through the dust separator 20 may flow upward, and then downward while passing through the impeller 51, and then may flow upward again to the air outlets 10a and 10a′.

The main body 10 may have the air outlets 10a and 10a′ through which air in the flow path P is discharged to the outside of the main body 10. The air outlets 10a and 10a′ may be formed in the discharge covers 12 and 12′.

The air outlets 10a and 10a′ may be formed in one surface of the main body 10. The air outlets 10a and 10a′ may be formed in an upper surface of the main body 10. In this manner, the air discharged through the air outlets 10a and 10a′ may prevent dust around the cleaner from scattering, as well as prevent the air discharged through the air outlets 10a and 10a′ from directly hitting a user. In addition, the sound outlet may be formed in the same surface as the surface in which the air outlets 10a and 10a′ are formed, among the surfaces of the main body 10.

The air outlets 10a and 10a′ may be disposed to face a specific direction (e.g., upwards). A discharge direction Ae of the air discharged through the air outlets 10a and 10a′ may be the specific direction.

In this specification, the term “predetermined axis O” means an imaginary axis extending across a center portion of the main body 10 in the specific direction. The term ‘centrifugal direction’ means a direction away from the axis O, and the term ‘direction opposite to the centrifugal direction’ means a direction approaching the axis O. In addition, the term ‘circumferential direction’ means a circumferential or rotational direction about the axis O. The circumferential direction includes clockwise and counterclockwise directions.

The discharge direction Ae of air may be a direction between the specific direction and the centrifugal direction. The discharge direction Ae of air may be a direction between the specific direction and the centrifugal direction. Specifically, the discharge direction Ae of air may be a direction between the specific direction and the counterclockwise direction. The discharge direction Ae of air may be a direction in which the specific direction, the centrifugal direction, and the circumferential direction are three-dimensionally combined.

The air outlets 10a and 10a′ may be disposed to surround the axis O. The air outlets 10a and 10a′ may be disposed or extend in a circumferential direction. The air outlets 10a and 10a′ may be disposed in predetermined peripheral areas B1 and B1′ extending over a central angle of 180 degrees along a circumferential direction around the predetermined axis O.

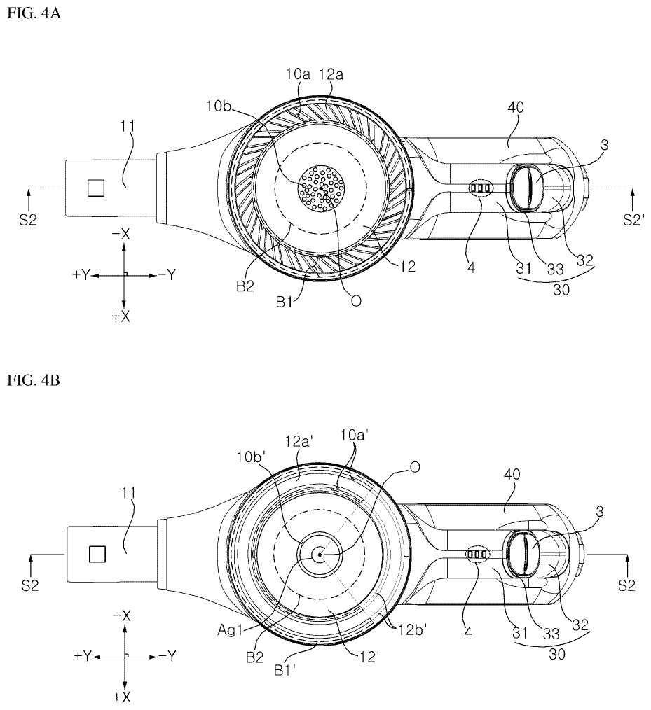

For example, referring to FIG. 4A, a peripheral area B1 may extend to a central angle of 360 degrees along the circumferential direction around the axis O. That is, the peripheral area B1 completely surrounds the circumference of the axis O.

In another example, referring to FIG. 4B, a peripheral area B1′ may extend by a central angle Ag1 along the circumferential direction around the axis O. Here, the central angle Ag1 may be a value greater than or equal to 270 degrees or more and less than 360 degrees. In FIG. 4A, the center angle Ag1 is about 270 degrees.

Referring to FIG. 4B, it is preferable that a direction in which the peripheral area B1′ is not surrounded relative to the axis O is a direction (rear) in which the handle 30 is disposed. The air outlet 10a′ may not be formed in an area between the axis O and the handle 30, so as to prevent the air, discharged from the air outlet 10a′, from flowing to a user side. A barrier 12b′ blocking the discharge of air may be provided in an area between the axis O and the handle 30. In this manner, it is possible to prevent the air, discharged from the air outlet 10a′, from directly hitting the user holding the handle 30.

In the peripheral areas B1 and B1′, the air outlets 10a and 10a′ may i) extend along the circumferential direction or ii) may be divided into a plurality of parts to be arranged along the circumferential direction. For example, referring to FIG. 4A, a plurality of air outlets 10a are arranged along the peripheral area B1. The plurality of air outlets 10a are separated from each other in the circumferential direction by a plurality of exhaust guides 12a. The plurality of air outlets 10a may be spaced apart from each other at predetermined intervals along the circumferential direction.

In another example, referring to FIG. 4B, the air outlets 10a are elongated along the peripheral area B1′. The plurality of air outlets 10a may be spaced apart from each other in a centrifugal direction. The exhaust guides 12a′ may divide the plurality of air outlets 10a′ in the centrifugal direction. The respective air outlets 10a′ may extend in the circumferential direction by the central angle Ag1 about the axis O.

The main body 10 includes exhaust guides 12a and 12a′ provided to allow the air, discharged through the air outlets 10a and 10a′, to be discharged in a direction inclined relative to the axis O. The exhaust guides 12a and 12a′ may be inclined relative to the axis O. The discharge covers 12 and 12′ may include the exhaust guides 12a and 12a′ for dividing the air outlets 10a and 10a′ into a plurality of parts.

For example, referring to FIG. 4A, the discharge cover 12 includes a plurality of exhaust guides 12a for dividing the air outlet 10a into a plurality of parts. The plurality of exhaust guides 12a are circumferentially spaced apart from each other. Each of the exhaust guides 12a extends in a direction between the circumferential direction and the centrifugal direction and divides two adjacent exhaust outlets 10a. A space between the two adjacent exhaust guides 12a serves as the air outlet 10a. The exhaust guide 12a guides air to be discharged in a direction in which the specific direction, the centrifugal direction, and the circumferential direction are three-dimensionally combined.

In another example, referring to FIG. 4B, the discharge cover 12′ includes one exhaust guide 12′ dividing the air outlet 10a′ into two parts. The exhaust guide 12a′ is elongated along the circumferential direction. The exhaust guide 12a′ extends from the one end of the barrier 12b′ to the other end thereof in the circumferential direction by the central angle Ag1 about the axis O. The exhaust guide 12a′ guides air to be discharged in a direction in which the specific direction and the centrifugal direction are combined.

The main body 10 has the sound outlets 10b and 10b′ through which the sound of the speakers 89 and 989 is emitted. The sound outlets 10b and 10b′ may be formed in the discharge covers 12 and 12′.

The sound outlets 10b and 10b′ may be formed in an upper surface of the main body 10. The outlets 10b and 10b′ may be disposed to face the specific direction (e.g., upwards). A sound emission direction Se of sound emitted through the outlets 10b and 10b′ may be the specific direction.

It is preferable that the sound outlets 10b and 10b′ are provided separately from the air outlets 10a and 10a′. In this manner, it is possible to prevent air or dust, moving in the flow path P, from affecting the performance of the speakers 89 and 989. Obviously, the sound outlets 10b and 10b′ may be omitted in some embodiments.

The air outlets 10a and 10a′ and the sound outlets 10b and 10b′ preferably face the same direction with respect to the main body 10. In this manner, when noise emitted through the air outlets 10a and 10a′ and sound emitted through the sound outlet 10b, 10b′ are synthesized to reach the user's ears, it is possible to reduce a phenomenon in which a ratio between the loudness of the noise and the loudness of the sound varies according to a position of the user's ears, and to synthesize the sound with the noise at a preset ratio.

The sound outlets 10b and 10b′ may be disposed at the center of the discharge covers 12 and 12′. The sound outlets 10b and 10b′ may be disposed in a centrifugal opposite direction of the peripheral areas B1 and B1′ with respect to the axis O. The sound outlets 10b and 10b′ may be disposed in a central portion through which the axis O passes. The sound outlets 10b and 10b′ may be spaced apart in the centrifugal opposite direction in the peripheral areas B1 and B1′ and may be disposed in a predetermined central area B2 through which the axis O passes. In this manner, an area of sound generation by the sound outlets 10b and 10b′ may be placed at the center of an area of noise generation by the air outlets 10a and 10a′, and noise generated by the air outlets 10a and 10a′ and the sound generated by the speakers 89 and 989 may act as destructive interference or constructive interference to each other in a predetermined manner. This is particularly effective in canceling out (destructive interference) a low-band frequency range of the generated noise with the 180 degree phase-shifted sound of the speakers 89 and 989.

For example, referring to FIG. 2, the sound outlet 10b may include a plurality of holes spaced apart from each other in the central area B2. In another example, referring to FIG. 4B, a mesh-type structure may be disposed in the central area B2, and a large number of holes formed in the mesh-type structure may perform a function of the sound outlet 10b. In yet another example, referring to FIG. 4B, the sound outlet 10b′ may include a gap elongated in the circumferential direction about the axis O within the central area B2. Specifically, the sound outlet 10b′ may include a ring-shaped gap.

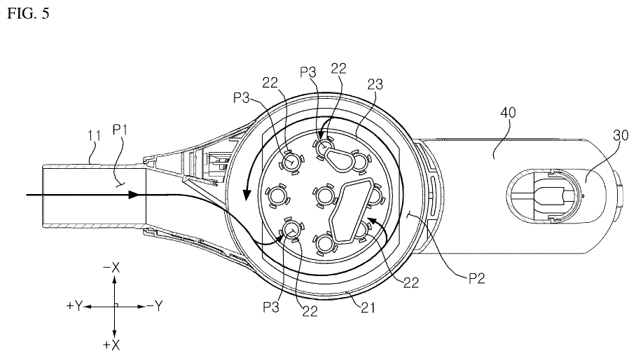

Referring to FIGS. 5 and 6, the dust separator 20 performs a function of filtering dust on the flow path P. The dust separator 20 separates dust, drawn into the main body 10 through the suction part 11, from the air.

For example, the dust separator 20 may include the first cyclone portion 21 and the second cyclone portion 22 capable of separating dust by cyclone flow. A flow path P2 formed by the first cyclone portion 21 may be connected to the flow path P1 formed by the suction part 11. Air and dust sucked through the suction part 11 helically flow along an inner circumferential surface of the first cyclone portion 21. An axis A2 of the cyclone flow of the first cyclone portion 21 may extend in a vertical or up-down direction. The axis A2 of the cyclone flow may coincide with the axis O. The second cyclone portion 22 further separates dust from the air having passed through the first cyclone portion 21. The second cyclone portion 22 may be disposed in the first cyclone portion 21. The second cyclone portion 22 may be disposed inside a boundary portion 23. The second cyclone portion 22 may include a plurality of cyclone bodies disposed in parallel.

In another example, the dust separator 20 may also have a single cyclone portion. Even in this case, the axis A2 of the cyclone flow may extend in the vertical direction.

In yet another example, the dust separator 20 may also include a main filter portion (not shown) instead of a cyclone portion. The main filter portion may separate dust from the air introduced from the suction part 11.

The following description will be given based on this embodiment in which the dust separator 20 includes the first cyclone portion 21 and the second cyclone portion 22, but is not necessarily limited thereto. The dust separator 20 includes dust separation flow paths P2 and P3. Air moves through the dust separation flow paths P2 and P3 at a high speed to separate dust from the air, and the separated dust is stored in the first dust storage space S1.

A space between an inner circumferential surface of the first cyclone portion 21 and an outer circumferential surface of the boundary portion 23 is the flow path P2 of the first cyclone. The air having passed through the suction flow path P1 moves in a downward spiral direction in the flow path P2 of the first cyclone, and dust in the air is centrifuged. Here, the axis A2 is the axis A2 of the downward spiral flow.

The dust separator 20 includes the boundary portion 23 having a cylindrical shape and disposed in the first cyclone portion 21. The boundary portion 23 has a plurality of holes formed in an outer circumferential surface thereof. The air in the flow path P2 of the first cyclone passes through the plurality of holes of the boundary portion 23 to be introduced into a second cyclone flow path P3. Bulky dust may also be filtered by the plurality of holes in the boundary portion 23.

An upper side of the second cyclone portion 22 is disposed in the boundary portion 23. The second cyclone portion 22 includes a plurality of cyclone bodies having an empty interior and penetrated vertically. Each cyclone body may be formed in a pipe shape that tapers downward. The second cyclone flow path P3 is formed in each cyclone body. The air having passed through the boundary portion 23 moves to the second cyclone flow path P3 along a guide disposed at the upper side of the cyclone body and guiding air flow in a downward spiral direction. The air moves in a downward spiral direction along the inner circumferential surface of the cyclone body, the dust in the air is centrifuged, and the separated air is stored in the second storage space S2. The air having moved to the lower side of the cyclone body along the second cyclone flow path P3 moves upward along a central axis in the vertical direction of the second cyclone flow path P3, and is introduced into the fan module flow paths P4 and P4′.

The dust separator 20 includes a dust flow guide 24 for dividing the first storage space S1 and the second storage space S2 within the dust collector 13. A space between the dust flow guide 24 and an inner surface of the dust collector 13 is the first storage space S1. An internal space of the dust flow guide 24 is the second storage space S2.

The dust flow guide 24 is coupled to the lower side of the second cyclone portion 22. The dust flow guide 24 contacts the upper surface of the dust cover 15. A portion of the dust flow guide 24 may have a diameter that decreases from top to bottom. For example, an upper portion of the dust flow guide 24 has a diameter that decreases toward the bottom, and a lower portion of the dust flow guide 24 may have a cylindrical shape that extends vertically.

The dust separator 20 includes a scattering prevention rib 25 extending downward from the upper end of the dust flow guide 24. The scattering prevention rib 25 may enclose a periphery of the upper portion of the dust flow guide 24. The scattering prevention rib 25 may extend along a circumferential direction about the flow axis A2. For example, the scattering prevention rib 25 may have a cylindrical shape.

If the upper portion of the dust flow guide 24 decreases toward the bottom, a space is formed between an outer peripheral surface of the upper portion of the dust flow guide 24 and the scattering prevention rib 25. When a rising flow of air occurs along the dust flow guide 24 in the first storage space S1, rising dust is caught by the space between the scattering prevention rib 25 and the dust flow guide 24. In this manner, it is possible to prevent the dust in the first storage space S1 from flowing backward to the top.

The handle 30 is coupled to the main body 10. The handle 30 may be coupled to the rear of the main body 10. The handle 30 may be coupled to the upper side of the battery housing 40.

The handle 30 includes the extension portion 31 protruding and extending rearward from the main body 10. The extension portion 31 may extend forward from the upper side of an additional extension portion 32. The extension portion 31 may extend horizontally. In the following embodiment B, the speaker 989 is disposed in the extension portion 31.

The handle 30 extends vertically and includes the additional extension portion 32. The additional extension portion 32 may be spaced apart from the main body 10 in a front-rear direction. A user may use the cleaner 1 while holding the additional extension portion 32. The upper end of the additional extension portion 32 is connected to a rear end of the extension portion 31. A lower end of the additional extension portion 32 is connected to the battery housing 40.

The additional extension portion 32 may be provided with a movement limiter 32a for preventing a user's hand from moving in a longitudinal direction (up and down direction) of the additional extension portion 32 while the user holds the additional extension portion 32. The movement limiter 32a may protrude forward from the additional extension portion 32.

The movement limiter 32a is vertically spaced apart from the extension portion 31. While the user holds the additional extension portion 32, some fingers of the user's hand holding the additional extension portion 32 are located over the movement limiter 32a, and the remaining fingers are located under the movement limiter 32a.

The handle 30 may include an inclined surface 33 facing a direction between the upper side and the rear side. The inclined surface 33 may be disposed on a rear surface of the extension portion 31. An input unit 3 may be disposed on the inclined surface 33.

The battery Bt may supply power to the fan modules 50 and 50′. The battery Bt may supply power to the noise control module. The battery Bt may be removably disposed in the battery housing 40.

The battery housing 40 is coupled to the rear of the main body 10. The battery housing 40 is disposed under the handle 30. The battery Bt is received in the battery housing 40. A heat dissipation hole for discharging heat, generated in the battery Bt, to the outside may be formed in the battery housing 40.

The fan modules 50 and 50′ generate a suction force to allow outside air to be introduced into the flow path P. The fan modules 50 and 50′ are disposed in the main body 10. The fan modules 50 and 50′ are disposed below the sound outlets 10b and 10b′. The fan modules 50 and 50′ are disposed above the dust separator 20.

The fan modules 50 and 50′ include impellers 51 and 51′ that generate a suction force by rotation. The impellers 51 and 51′ pressurize air so that the air in the flow path P is discharged through the air outlets 10a and 10a′. Noise and vibration occurs when the impellers 51 and 51′ pressurize air, and the noise is mainly emitted through the air outlets 10a and 10a′.

An extension line of a rotational axis A1 (also referred to as a shaft of a suction motor) of the impellers 51 and 51′ may coincide with the flow axis A2. In addition, the rotational axis A1 may coincide with the axis O. In this case, the impellers 51 and 51′ rotate about the axis O to pressurize air. In this manner, noise may be emitted relatively evenly through the air outlets 10a and 10a formed in the peripheral areas B1 and B1′.

The fan modules 50 and 50′ include suction motors 52 and 52′ for rotating the impeller 51. The suction motors 52 and 52′ may be the only motors of the cleaner 1. The suction motors 52 and 52′ may be disposed above the dust separator 20. Noise and vibration occur during operation of the suction motors 52 and 52′, and the noise is mainly emitted through the air outlets 10a and 10b′.

For example, the fan module 50 in which the impeller 51 is disposed under the suction motor 52 may be provided. The impeller 51 pressurizes air in an upward direction while rotating.

The fan modules 50 and 50′ may include a shaft 53 fixed to the center of the impellers 51 and 51′. The shaft 53 extends vertically on the rotational axis A1. The shaft 53 may function as a motor shaft of the suction motor 52.

The cleaner 1 may include a printed circuit board (PCB) 55 for controlling the suction motors 52 and 52′. The PCB 55 may be disposed between the suction motor 52 and the dust separator 20.

Referring to FIG. 6, the cleaner 1 may include a pre-filter 61 for filtering air before air is drawn into the suction motors 52 and 52′. The pre-filter 61 may be disposed to enclose the impeller 51. Air on the fan module flow paths P4 and P4′ may pass through the pre-filter 561 to reach the impeller 51. The pre-filter 61 is disposed inside the main body 10. The pre-filter 61 is disposed under the discharge covers 12 and 12′. By separating the discharge covers 12 and 12′ from the cleaner 1, a user may remove the pre-filter 61 from the inside of the main body 10.

The cleaner 1 may include a high-efficiency particulate air (HEPA) filter 62 for filtering air before the air is discharged through the air outlets 10a and 10a′. The air having passed through the impellers 51 and 51′ may pass through the HEPA filter 62 to be discharged to the outside through the air discharge port 10a. The HEPA filter 62 is disposed on the exhaust flow path P5.

The discharge covers 12 and 12′ may have a filter receiving space (not shown) for receiving the HEPA filter 62. The filter receiving space has an open bottom, such that the HEPA filter 62 may be received in the filter receiving space at the lower side of the discharge covers 12 and 12′.

The air outlet 10a may be formed to face the HEPA filter 62. The HEPA filter 62 is disposed under the air outlets 10a and 10a′. The HEPA filter 62 may extend in a circumferential direction along the air outlets 10a and 10a′.

The main body 10 includes a filter cover 17 covering the lower surface of the HEPA filter 62. While the HEPA filter 62 is received in the filter receiving space, a lower side of the HEPA filter 62 is covered by the filter cover 17, and the filter cover 17 has a hole through which air in the exhaust flow path P5 passes. The filter cover 17 may be removably coupled to the discharge covers 12 and 12′.

The discharge covers 12 and 12′ may be removably coupled to the fan module housing 14. When the filter cover 17 is removed from the discharge covers 12 and 12′ separated from the fan module housing 14, the HEPA filter 62 may be removed from the filter receiving space. In the present disclosure, the cleaner 1 includes the pre-filter 61 and the HEPA filter 62, but there is no limitation on the type and number of filters.

The input unit 3 may be located on an opposite side of the movement limiter 32a with respect to the handle 30. The input unit 3 may be disposed on the inclined surface 33.

In addition, the output unit 4 may be disposed at the extension portion 31. For example, the output unit 4 may be disposed on an upper surface of the extension portion 31. The output unit 4 may include a plurality of light emitters. The plurality of light emitters may be spaced apart from each other in a longitudinal direction (front-rear direction) of the extension portion 31.

The flow path P is formed by sequentially connecting the suction flow path P1, dust separation flow paths P2 and P3, fan module flow path P4, and exhaust flow path P5.

The air and dust drawn in through the suction flow path P1 by the operation of the suction motors 52 and 52′ flow in the first cyclone flow path P2 and the second cyclone flow path P3 and are separated from each other. In the second cyclone flow path P3, air moves upward as described above, and is introduced into the fan module flow paths P4 and P4′. The fan module flow paths P4 and P4′ guide air toward the pre-filter 61. Air sequentially having passed through the pre-filter 61 and the impeller 51 flows into the exhaust flow paths P5 and P5′. The air in the exhaust flow paths P5 and P5′ passes through the HEPA filter 62, to be discharged to the outside through the air outlets 10a and 10a′.

For example, the fan module flow path P4 guides the air so that the air discharged from the dust separator 20 rises, and then descends while passing through the impeller 51. Here, the exhaust flow path P5 guides the air so that the air descending while passing through the impeller 51 rises again to the air outlets 10a and 10a′.

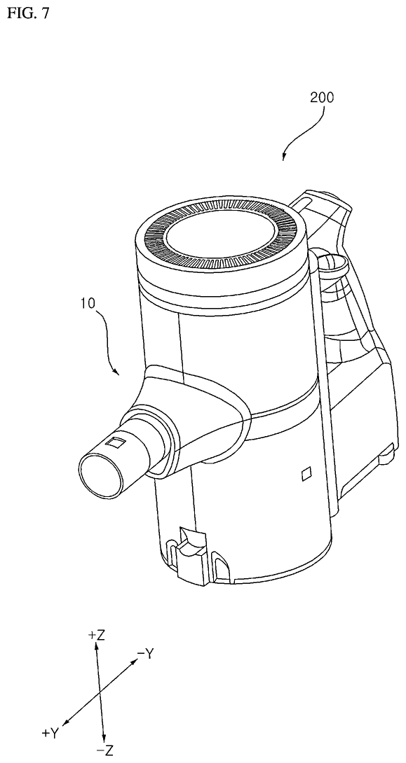

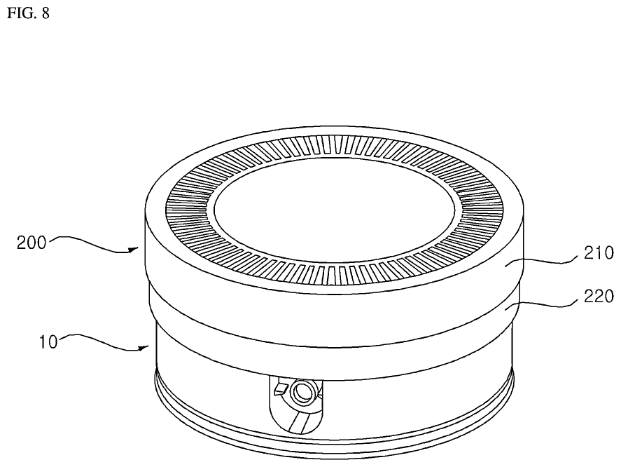

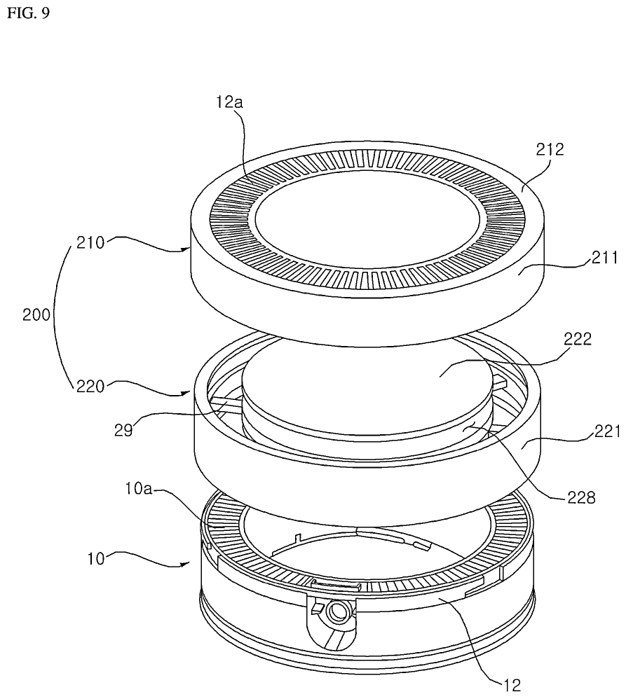

Hereinafter, a noise reduction device 200 (or noise reduction cap) coupled to a cleaner and configured to reduce noise emitted by the cleaner will be described in detail. FIG. 7 is a perspective view of a noise reduction device 200 coupled to the cleaner 1 illustrated in FIG. 2 according to an embodiment of the present disclosure, FIG. 8 is a diagram illustrating only an upper portion of a main body of the cleaner and the noise reduction device 200 of FIG. 7 according to an embodiment of the present disclosure, and FIG. 9 is an exploded view of the cleaner and the noise reduction device 200 illustrated in FIG. 8.

Referring to FIGS. 7 to 9, the noise reduction device 200 according to an embodiment of the present disclosure may be coupled to the main body 10. Specifically, the noise reduction device 200 may be coupled to an upper end of the main body 10.

The main body 10 has a cylindrical shape, and a portion of the noise reduction device 200 that is coupled to the main body 10 may also have a cylindrical shape corresponding to the main body 10. More specifically, a lower portion of the noise reduction device 200 may be disposed to surround an outer circumferential surface of the upper portion of the main body 10 and an outer circumferential surface of the discharge cover 12. In this case, the noise reduction device 200 may overlap the air outlet 10a in a vertical direction or in a direction of the rotational axis A1 of the impellers 51 and 51′.

In addition, in an example in which the air outlet 10a has a ring shape surrounding the rotational axis A1 of the impellers 51 and 51′ and a sound outlet (not shown) is disposed at the center of the air outlet 10a, the noise reduction device 200 may overlap the sound outlet in a vertical direction or in a direction of the rotational axis A1 of the impellers 51 and 51′.

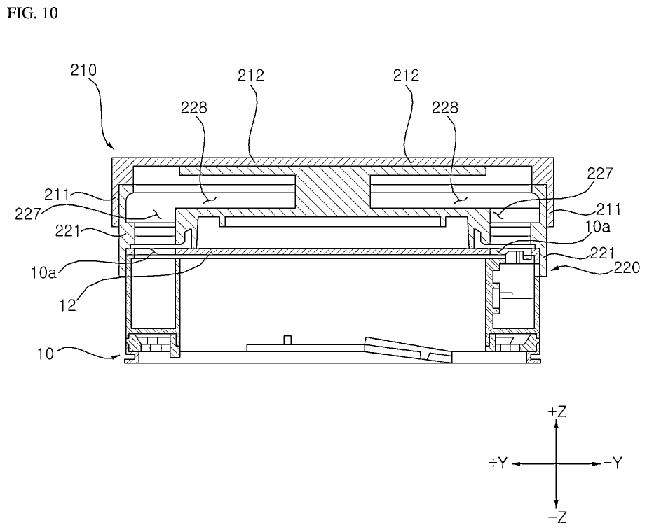

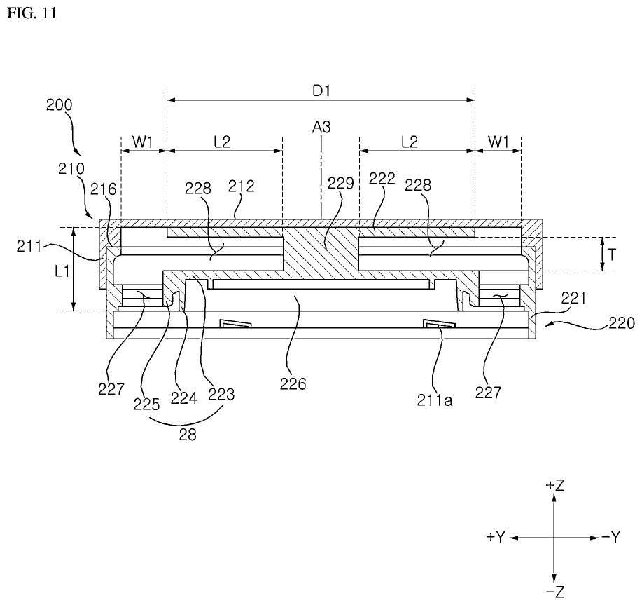

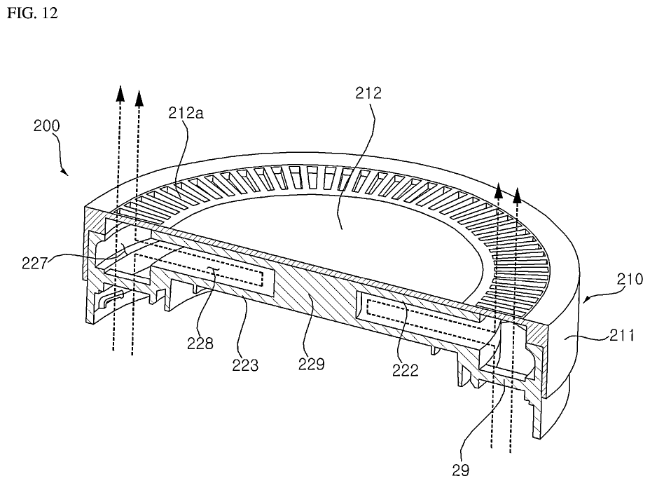

Hereinafter, a structure of the noise reduction device 200 according to an embodiment of the present disclosure will be described in further detail. FIG. 10 is a longitudinal sectional view of the noise reduction device 200 and the cleaner illustrated in FIG. 8, FIG. 11 is a longitudinal sectional view of a noise reduction device according to an embodiment of the present disclosure, and FIG. 12 is an exploded perspective view of the noise reduction device illustrated in FIG. 11.

Referring to FIGS. 10 to 12, the noise reduction device 200 according to an embodiment of the present disclosure includes a lower member (or lower housing) 220 coupled to the cleaner and defining a portion or entirety of the first flow path 227, and an upper member (or upper housing) 210 coupled to the lower member 220, defining another portion of the first flow path 227, and defining an outlet of the first flow path 227. Obviously, in another embodiment of the noise reduction device 200, the upper member 210 and the lower member 220 may be integrally formed with each other.

The lower member 220 is coupled to the cleaner and defines a portion or entirety of the first flow path 227. Air discharged through the air outlet 10a is discharged in a ring shape according to the shape of the impellers 51 and 51′. Accordingly, the lower member 220 discharges the air, discharged in the ring shape through the air outlet 10a, to the outside and is coupled to the main body 10.

For example, the lower member 220 includes: a lower lateral surface (or lower lateral wall) 221 defining a lower space 226 centered around a first direction as a central axis A3; a lower cover 28 disposed in the lower space defined by the lower lateral surface 221, and defining a first flow path 227 formed between the lower lateral surface 221 and the lower cover 28 and defining a lower surface of the second flow path 228; and a lower top surface (or lower top wall) 222 disposed in the lower space 28 and defining an upper surface of the second flow path 228.

The lower lateral surface 221 may have a cylindrical shape centered around a vertical direction as the central axis A3. More preferably, the lower lateral surface 221 may have a cylindrical shape centered around the central axis A3 that coincides with the rotational axis A1 of the impellers 51 and 51′.

The lower cover 28 is disposed in the lower space 226. The lower cover 28 guides the air, supplied through the air outlet 10a having a ring shape, in an upward direction. The first flow path 227 is defined between the lower cover 28 and the lower lateral surface 221.

The lower cover 28 is disposed at a position spaced apart from the lower top surface 222 and the lower lateral surface 221. The first flow path 227 having a ring shape is formed between the lower cover 28 and the lower lateral surface 221. The first flow path 227 has a ring shape surrounding the central axis A3 and extends vertically. A lower end of the first flow path 227 communicates with the air outlet 10a and has a shape corresponding to the air outlet 10a.

In addition, the lower cover 28 defines a lower surface of the second flow path 228. The second flow path 228 is formed between the lower cover 28 and the lower top surface 222. The second flow path 228 extends in a direction parallel to a horizontal direction. An outer end of the second flow path 228 communicates with a middle upper end of the first flow path 227.

The lower top surface 222 is disposed in the lower space and defines a top surface of the second flow path 228. The lower top surface 222 may have a circular shape when viewed from above. The lower top surface 222 may overlap the lower cover 28 when viewed from above.

The lower cover 28 and the lower top surface 222 are connected to each other by a lower connection part (or lower connection wall) 229. Accordingly, the lower cover 28 and the lower top surface 222 are spaced apart by the lower connection part 229. The lower connection part 229 may overlap the central axis A3. Accordingly, the second flow path 228 may be symmetrical about the central axis A3.

The second flow path 228 has a ring shape surrounding the central axis A3. Specifically, the second flow path 228 has a ring shape surrounding the central axis A3 or the lower connection part 229, and the first flow path 227 has a ring shape surrounding the second flow path 228.

A width of the second flow path 228 may be uniform in the second direction or may be variable. A thickness T of the second flow path 228 may be uniform in the second direction or may be variable. For example, a thickness of an outer end of the second flow path 228 may be greater than a thickness of an inner end of the second flow path 228. In another example, the thickness T of the second flow path 228 may decrease toward the central axis A3.

For example, the lower cover 28 may include a cover top surface 223 vertically overlapping a portion of the lower top surface 222 and defining a lower surface of the second flow path 228, and a cover lateral surface 225 extending downward from an outer end of the cover top surface 223.

The cover top surface 223 may have a circular shape centered around the central axis A3. The cover lateral surface 225 may have a ring shape surrounding the central axis A3. The first flow path 227 is defined between the cover lateral surface 225 and the lower lateral surface 221. The second flow path 228 is defined between the cover top surface 223 and the lower top surface 222.

A lower end of the cover lateral surface 225 may be disposed above a lower end of the lower lateral surface 221. The lower end of the cover lateral surface 225 contacts a top surface of the discharge cover 12, and the lower end of the lower lateral surface 221 contacts an outer surface of the discharge cover 12. The air outlet 10a may be formed between the cover lateral surface 225 and the lower lateral surface 221.

The cover lateral surface 225 and the upper surface of the discharge cover 12 are required to closely contact each other in order to prevent leakage of air discharged through the air outlet 10a. Accordingly, in order to prevent leakage of air, the lower cover 25 may further include a cover sealing part 224.

The cover sealing part 224 may be located further inward than the cover lateral surface 225 and may have a ring shape surrounding the central axis A3. A lower end of the cover sealing part 224 is connected to the cover top surface 223, and the lower end of the cover sealing part 224 contacts the upper end of the discharge cover 12.

The lower member 220 may further include an arm 29 for fixing the position of the lower cover 28. A plurality of arms 29 may be provided, which fix the position of the lower cover 28 by connecting the lower cover 28 and the lower lateral surface 221.

The lower member 220 may further include a fastening part 211a fastened to the cleaner. The fastening part 211a may be formed on the lower lateral surface 221. The fastening part 211a is disposed on an inner surface of the lower lateral surface 221, to be fastened to an outer circumferential surface of the discharge cover 12 according to a shape. The fastening part 211a may have various fastening structures in which the fastening part 211a is fastened by rotating about the central axis A3 or by moving up and down. For example, the fastening part 211a may include at least one of a hook, a groove, and a protrusion.

The lower member 220 may further include a lower support 228 limiting the position of the cleaner. The lower support 228 contacts an upper end of the discharge cover 12. The lower support 228 may be a protrusion protruding inward from the lower lateral surface 221 or may be a step protruding inward from the lower lateral surface 221.

The upper member 210 may be coupled to the lower member 220, and may define another portion of the first flow path 217. In another example, the upper member 210 may include an upper hole 212a coupled to the lower member 220 and connected to an upper end of the first flow path 227.

For example, the upper member 210 includes an upper lateral surface (or upper lateral wall) 211 defining an upper space centered around a first direction as a central axis A3, an upper top surface (or upper top wall) 212 coupled to one end of the upper lateral surface 221 and covering the upper space 219, and a plurality of upper holes 212a formed in the upper top surface 212 and communicating with the first flow path 227.

The upper lateral surface 211 may have a cylindrical shape centered around a vertical direction as the central axis A3. More preferably, the upper lateral surface 211 may have a cylindrical shape centered around the central axis A3 that coincides with the rotational axis A1 of the impellers 51 and 51′. A diameter of the upper lateral surface 211 may be greater than a diameter of the lower lateral surface 221.

The upper top surface 212 is coupled to the upper end of the upper lateral surface 211 to extend in a horizontal direction perpendicular to the upper lateral surface 211. The upper top surface 212 may have a circular shape when viewed from above. The upper top surface 212 may contact the lower top surface 222.

The upper top surface 212 has an upper hole 212a. The upper hole 212a is formed through the upper top surface 212. A plurality of upper holes 212a may be formed, and the plurality of upper holes 212a may be arranged on a closed curve surrounding the central axis A3.

The upper hole 212a may overlap the first flow path 227 in the first direction. The upper hole 212a may have various shapes, but preferably has a slit shape when viewed from above. The upper hole 212a is disposed so as not to vertically overlap the second flow path 228.

Obviously, a portion of the upper lateral surface 211 may define a portion of an upper end of the first flow path 227 in some embodiments. A portion of the upper end of the first flow path 227 is defined between a portion of the upper lateral surface 211 and the lower top surface 222.

A portion of the lower lateral surface 221 is inserted into the upper lateral surface 211. An inner surface of the lower end of the upper lateral surface 211 may contact an outer surface of an upper end of the lower lateral surface 221.

The upper top surface 212 is disposed above the lower top surface 222, and the upper lateral surface 211 may further include an upper support 216 that supports the lower lateral surface 221 to determine a distance between the lower top surface 222 and the upper top surface 212. The upper support 216 contacts the lower top surface 221. The upper support 216 may be a protrusion protruding inward from the upper lateral surface 211 or may be a step protruding inward from the upper lateral surface 211.

A first end of the second flow path 228 is connected between the first and second ends of the first flow path 227, and a second end of the second flow path 228 is closed and extends in a second direction intersecting the first direction. When the air introduced through the first flow path 227 is reflected from the closed end of the second flow path 228 to be introduced back into the first flow path 227, an incident wave entering the second flow path 228 has an opposite phase to a reflected wave exiting the second flow path 228, and the waves are destructively superposed on each other, thereby reducing noise. That is, the first flow path 227 having a ring shape extends vertically, and the second flow path 228 extends from the middle of the first flow path 227 toward the center of the first flow path 227.

The second flow path 228 may be a space defined by the lower top surface 222, the cover top surface 223, and the lower connection part 229. The second flow path 228 may be a space between the lower top surface 222 and the cover top surface 223, and one end of the second flow path 228 is closed by the lower connection part 229.

One end of the second flow path 228 is connected between the lower end and the upper end of the first flow path 227. Accordingly, a target frequency for reducing noise may be determined by adjusting the length L2 of the second flow path 228. The second flow path 228 preferably extends in a direction perpendicular to the first flow path 22. Obviously, if the second flow path 228 extends in a direction intersecting the first flow path 227 rather than in a direction perpendicular to the first flow path 227, the length L2 of the second flow path 228 refers to a length in a direction perpendicular to the first flow path 227.

The second flow path 228 may be disposed to surround the lower connection part 229. The second flow path 228 may have a ring shape centered around the central axis A3. In the case where the second flow path 228 has a ring shape surrounded by the first flow path 227, a much greater noise reduction effect may be achieved and less space is required, compared to the case where the second flow path 228 has a single line shape.

Preferably, an outer end of the second flow path 228 may be connected to an inner end of the first flow path 227. The second flow path 228 may be symmetrical with respect to the lower connection part 229. That is, the air introduced through the first flow path 227 is introduced toward the inner circumference, and then is reflected back, thereby maximizing the noise reduction effect.

A width W1 of the first flow path 227 may be greater than a thickness T of the second flow path 228. If the thickness T of the second flow path 228 is too small, the noise reduction effect is reduced, and if the width W1 of the first flow path 227 is too small, the suction performance of the cleaner is reduced.

A length L1 of the first flow path 227 may be smaller than a length L2 of the second flow path 228. The length L1 of the first flow path 227 is a vertical length, and the length L2 of the second flow path 228 may be a horizontal length. If the length L1 of the first flow path 227 is greater than the length L2 of the second flow path 228, a thickness of the noise reduction device increases, and the length L2 of the second flow path 228 is reduced, such that a sufficient noise reduction effect may not be produced.

The length L2 of the second flow path 228 may be smaller than a diameter D1 of a ring shape defined by the second flow path 228. The length L2 of the second flow path 228 may be preferably smaller than a radius of the ring shape defined by the second flow path 228. The length L2 of the second flow path 228 is smaller than the radius of the ring shape defined by the second flow path 228, such that the noise reduction device may be manufactured in a slim structure according to a shape of the air outlet. The length L1 of the first flow path 227 may be smaller than the length L2 of the second flow path 228, and may be greater than the thickness T of the second flow path 228.

Hereinafter, a moving path of air and noise reduction will be described in detail with reference to FIG. 12. Air discharged from the cleaner is discharged through the air outlet 10a, and air discharged from the air outlet 10a is discharged to the outside through the first flow path 227.

A portion of the air flowing through the first flow path 227 is introduced into the second flow path 228 and is reflected from the closed end of the second flow path 228 to be introduced back into the first flow path 227, and thus is canceled out by opposite wavelengths, thereby reducing noise.

A width of the second flow path 228 may decrease toward the central axis A3 parallel to the first direction. A width of an outer end of the second flow path 228 may be greater than a width of an inner end of the second flow path 228.

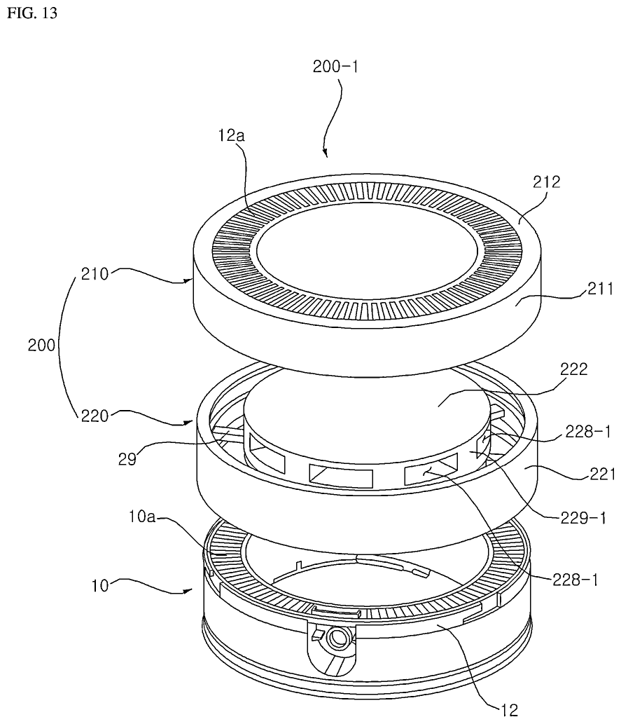

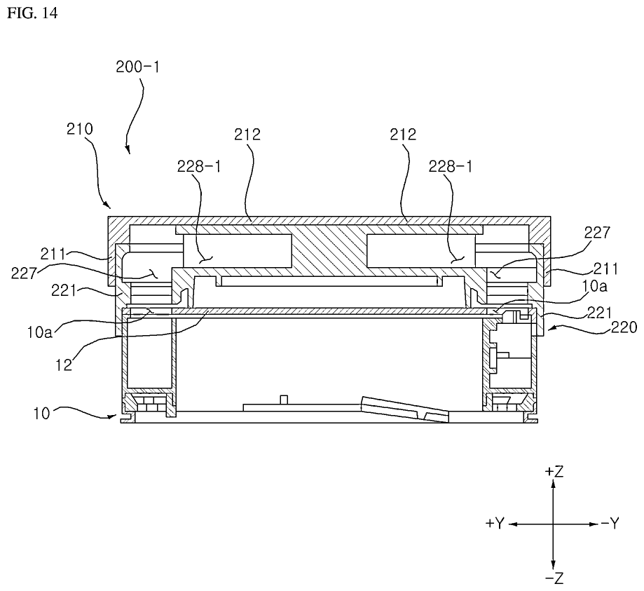

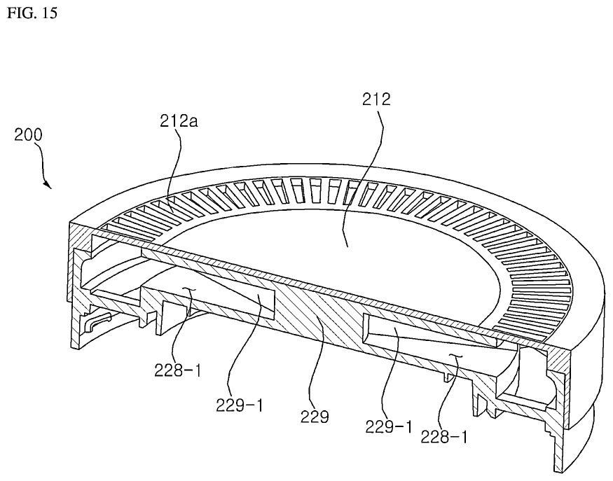

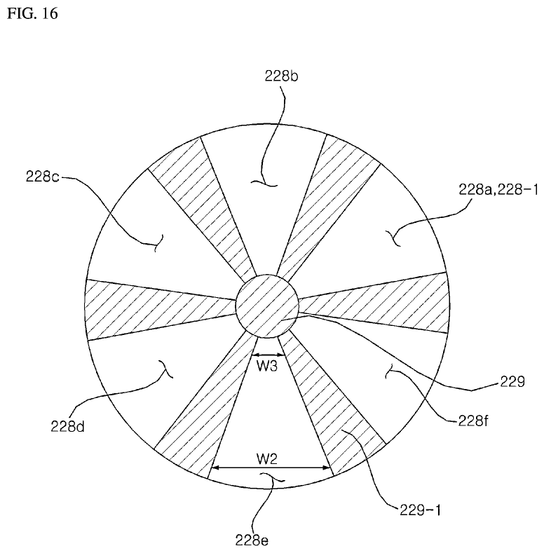

FIG. 13 is an exploded perspective view of a noise reduction device according to another embodiment of the present disclosure, FIG. 14 is a longitudinal sectional view of a noise reduction device according to another embodiment of the present disclosure, FIG. 15 is a cross-sectional perspective view of the noise reduction device illustrated in FIG. 14, and FIG. 16 is a view of a portion of a lower member of FIG. 15 when viewed from the central axis A3.

Referring to FIGS. 13 to 16, a noise reduction device 200-1 according to another embodiment of the present disclosure is different from the embodiment of FIG. 11 in that there is a difference in a structure of a second flow path 220-1. The following description will focus on the difference from FIG. 11, and components not specifically described herein will be considered the same as those in the embodiment of FIG. 11.

The second flow path 228-1 includes a plurality of sub-flow paths 228a to 228f. The respective sub-flow paths 228a to 228f may extend from an inner end of the first flow path 227 toward the central axis A3.

In this case, due to a limited space surrounded by the first flow path 227, the sub-flow paths 228a to 228f may decrease in width toward the central axis A3. A width W2 of an outer end of the respective sub-flow paths 228a to 228f may be greater than a width of an inner end W1 of the respective sub-flow paths 228a to 228f.

The lower connection part 229 may further include a sub-connection part 229-1 extending radially from an outer end of the lower connection part 229. An upper end of the sub-connection part 229-1 is connected to the lower top surface 222 and is connected to a cover top surface at a lower end of the sub-connection part 229-1. A plurality of sub-connection parts 22-1 are circumferentially spaced apart from each other, such that the sub-flow paths 228a to 228f are defined between adjacent sub-connection parts 229-1.

The respective sub-flow paths 228a to 228f may have the same length or different lengths, and may have the same thickness or different thicknesses. Noise in various frequency ranges may be reduced by the plurality of sub-flow paths 228a to 228f, thereby facilitating design modification.

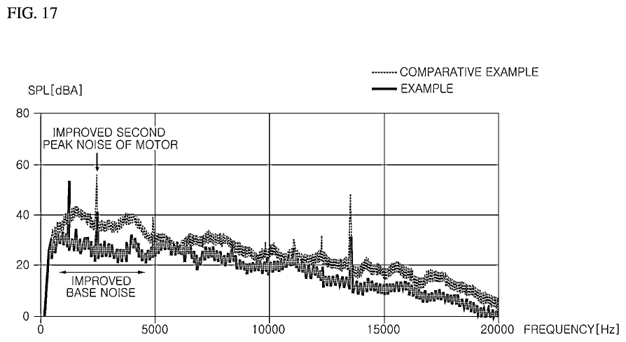

FIG. 17 is a diagram illustrating levels of noise with respect to frequency in a comparative example and an example. Referring to FIG. 17, the comparative example shows experimental data about a cleaner without the noise reduction device 200.

Based on results obtained by measuring noise in various frequency ranges, it can be seen that noise is reduced over all frequency ranges. Particularly, it can be seen that base noise, which is difficult to be reduced, is reduced significantly.

In the above structure, the cleaner according to the present disclosure includes the first flow path, through which air introduced from the air outlet of the cleaner flows, and the second flow path extending in a direction intersecting the first flow path, in which an incident wave entering the second flow path is reflected from an end of the second flow path, and thus has an opposite phase to a reflected wave exiting the second flow path, such that noise generated during operation of the cleaner may be reduced by resonance sound absorption without affecting cleaning performance.

In addition, the noise reduction device according to the present disclosure is coupled to an air outlet and has a cylindrical shape corresponding to the shape of a cleaner main body, in which noise is reduced by using the cylindrical shape and flow paths extending in a direction intersecting the axis of a cylinder, such that the noise reduction device may be manufactured with a slim design, and the cleaner does not significantly increase in size when the noise reduction device is coupled to the cleaner.

Furthermore, the noise reduction device according to the present disclosure has a structure in that the second flow path for reducing noise and the first flow path connected to the air outlet are defined in the lower member, and the upper member covers the top of the lower member, such that noise in various frequency ranges may be reduced by changing the lower member, and structural tuning to noise frequencies may be easily achieved.

In addition, the noise reduction device according to the present disclosure may be removably mounted to the air outlet of the cleaner main body, such that the noise reduction device may be coupled to the main body when a user wants to reduce noise, and may be easily removed when the user does not want to reduce noise.

It is a first objective of the present disclosure to reduce noise, generated during operation of a cleaner, by using a resonance sound-absorbing effect without affecting the cleaning performance. It is a second objective of the present disclosure to prevent air from being discharged to a user's face, while effectively reducing noise in limited height conditions. It is a third objective of the present disclosure to reduce noise of various frequencies by using a plurality of second flow paths of a lower member which are designed in various lengths and widths.

In order to achieve the above objectives, a noise reduction device for use in a cleaner according to an embodiment of the present disclosure includes: a first flow path having a first end communicating with an air outlet and a second end that is open, the first flow path extending in a first direction; and a second flow path having a first end connected between the first end and the second end of the first flow path and a second end that is closed, the second flow path extending in a second direction intersecting the first direction, wherein the first flow path is disposed to surround the second flow path.

The first flow path may have a ring shape that surrounds a central axis parallel to the first direction. The second flow path may have a ring shape that surrounds a central axis parallel to the first direction.

The second flow path may extend from an inner end of the first flow path toward the central axis parallel to the first direction. The second flow path may have a uniform width.

A width of an outer end of the second flow path may be greater than a width of an inner end of the second flow path. The second flow path may have a uniform thickness. A thickness of an outer end of the second flow path may be greater than a thickness of an inner end of the second flow path.

A width of the second flow path may decrease toward the central axis parallel to the first direction. A length of the first flow path may be smaller than a length of the second flow path. A length of the second flow path may be smaller than a radius of a ring shape defined by the second flow path.

A width of the first flow path may be greater than a thickness of the second flow path. A length of the first flow path may be smaller than a length of the second flow path and may be greater than a thickness of the second flow path.

The second flow path may include a plurality of sub-flow paths. The sub-flow paths may extend from an inner end of the first flow path toward the central axis parallel to the first direction. The sub-flow paths may decrease in width toward the central axis parallel to the first direction.

In addition, the noise reduction device may further include a lower member coupled to the cleaner and defining a portion of the first flow path and the second flow path. The lower member may include: a lower lateral surface defining a lower space centered around the first direction; a lower cover disposed in the lower space defined by the lower lateral surface, and defining a first flow path which is formed between the lower lateral surface and the lower cover and defining a lower surface of the second flow path; and a lower top surface disposed in the lower space and defining an upper surface of the second flow path.

The noise reduction device may further include a lower connection part connecting the lower cover and the lower top surface. The lower connection part may be disposed to overlap the central axis.

The noise reduction device may further include an upper member coupled to the lower member and defining another portion of the first flow path. The upper member may include: an upper lateral surface defining an upper space centered around the first direction; an upper top surface connected to one end of the upper lateral surface and covering the upper space; and a plurality of upper holes formed in the upper top surface and communicating with the first flow path.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A noise reduction device for use in a cleaner comprising:
a first flow path having a first end that communicates with an air outlet of the cleaner, and a second end that is open, the first flow path extending in a first direction; and
a second flow path having a first end connected to the first flow path between the first end and the second end of the first flow path, and a second end that is closed, the second flow path extending in a second direction intersecting the first direction,
wherein the first flow path is disposed around the second flow path in a plan view.

2. The noise reduction device of claim 1, wherein the first flow path has a ring shape around a central axis that extends parallel to the first direction.

3. The noise reduction device of claim 1, wherein the second flow path has a ring shape around a central axis that extends parallel to the first direction.

4. The noise reduction device of claim 2, wherein the at least one second flow path extends from the first flow path and toward the central axis.

5. The noise reduction device of claim 1, wherein the second flow path has a uniform width.

6. The noise reduction device of claim 1, wherein a width of the first end of the second flow path is greater than a width of the second end of the second flow path.

7. The noise reduction device of claim 1, wherein the second flow path has a uniform thickness.

8. The noise reduction device of claim 1, wherein a thickness of the first end of the second flow path is greater than a thickness of the second end of the second flow path.

9. The noise reduction device of claim 1, wherein a width of the second flow path decreases toward a central axis that extends parallel to the first direction.

10. The noise reduction device of claim 1, wherein a length of the first flow path is less than a length of the second flow path.

11. The noise reduction device of claim 2, wherein the second flow path has a ring shape, and a length of the second flow path is less than a radius of the ring shape defined by the second flow path.

12. The noise reduction device of claim 1, wherein a width of the first flow path is greater than a thickness of the second flow path.

13. The noise reduction device of claim 1, wherein a length of the first flow path is less than a length of the second flow path and is greater than a thickness of the second flow path.

14. The noise reduction device of claim 1, wherein the second flow path comprises a plurality of sub-flow paths that communicate with the first flow path.

15. The noise reduction device of claim 14, wherein each of the plurality of sub-flow paths extends from the first flow path and toward a central axis that is parallel to the first direction.

16. The noise reduction device of claim 14, wherein each of the sub-flow paths decreases in width in a direction from the first flow path and toward a central axis that is parallel to the first direction.

17. The noise reduction device of claim 1, further comprising a lower housing that is configured to be coupled to the cleaner and that defines a portion of the first flow path and the second flow path.

18. The noise reduction device of claim 17, wherein the lower housing comprises:
a lower lateral wall defining sides of a lower space;
a lower cover disposed in the lower space defined by the lower lateral wall, the portion of the first flow path being defined between the lower lateral wall and the lower cover, and the lower cover defining a lower surface of the second flow path; and
a lower top wall disposed in the lower space and defining an upper surface of the second flow path.

19. The noise reduction device of claim 18, further comprising a lower connection wall connecting the lower cover and the lower top wall.

20. The noise reduction device of claim 19, wherein the lower connection wall is disposed to overlap a central axis that extends parallel to the first direction.

21. The noise reduction device of claim 17, further comprising an upper housing that is coupled to the lower housing and that defines another portion of the first flow path.

22. The noise reduction device of claim 21, wherein the upper housing comprises:
an upper lateral wall defining sides of an upper space;
an upper top wall that is connected to one end of the upper lateral wall and that is positioned over the upper space; and
a plurality of upper holes that are provided in the upper top wall and communicate with the first flow path.
